(19) United States
(12) Patent Application Publication
(10) Pub. No.: US 2026/0351931 A1
(43) Pub. Date: Nov. 5, 2026

(54) MANUALLY OPERABLE CUTTING TOOL

(71) Applicant: KNIPEX-Werk C. Gustav Putsch KG, Wuppertal (DE)

(72) Inventors: Jan SCHLEIMINGER, Solingen (DE); Tim LIEDTKE, Wuppertal (DE); Marcel BONSS, Schmalkalden (DE)

(73) Assignee: KNIPEX-Werk C. Gustav Putsch KG, Wuppertal (DE)

(21) Appl. No.: 19/101,936

(22) PCT Filed: Aug. 8, 2023
(86) PCT No.: PCT/EP2023/071893

§ 371 Date: Feb. 7, 2025

(30) Foreign Application Priority Data
Aug. 12, 2022 (DE) 10 2022 120 493.6
Nov. 11, 2022 (DE) 10 2022 129 901.5

(51) Int. Cl. H02G 1/12; H02G 1/00

(52) U.S. Cl. CPC H02G 1/1214; H02G 1/005

(57) ABSTRACT

A manually operable cutting tool includes a first tool leg and a second tool leg, which about an axis of rotation, the tool legs forming a cutting mouth. Working surfaces of the cutting mouth are formed with cutting edges. A working surface of the first tool leg includes first and second cutting edges. The cutting edge transitions into the second cutting edge via a projecting shoulder, the shoulder coming into a position one over the other with the second tool leg such that an opening region remains between the cutting edges of the tool legs.

### TECHNICAL FIELD

The invention pertains to a manually operable cutting tool with two tool legs, namely a first and a second tool leg, which can be pivoted relative to one another about an axis of rotation along a pivot plane, wherein the tool legs form handle sections on one side of the axis of rotation and a cutting mouth on the other side of the axis of rotation, wherein working surfaces of the cutting mouth furthermore are realized with cutting edges and a working surface of the first tool leg comprises first and second cutting edges, wherein the first cutting edge of the first tool leg transitions into a shoulder, which projects in relation to the second cutting edge in a closing direction, at the transition to the second cutting edge, wherein the shoulder first comes into a superimposed position with the second tool leg in a closing region in a first closing position during the movement into a closing position of the cutting tool, and wherein, in the first closing position, the closing region is, viewed from the axis of rotation in a radial direction, formed on a radial end of an opening region remaining between the first cutting edge of the first tool leg and the second tool leg in the first closing position.

### PRIOR ART

Cutting tools of the type in question primarily serve for cutting cables or also wires, which with respect to their material consist, for example, of copper, steel or glass fibers. Cutting tools of this type are also referred to as so-called cable cutters or cable cutting pliers, wherein the handle sections of pliers-like cutting tools are realized in an elongate, rod-shaped manner, usually without the formation of an eyelet-like through-hole for the fingers as is typically provided on scissors.

A cutting tool of the type in question is known from publication DE 10 2009 044 107 A1. This cutting tool is realized in the form of pliers and comprises in the region of both tool legs first and second cutting edges that, starting from the axis of rotation, are successively arranged in the radial direction, wherein said first and second cutting edges are respectively separated from one another by a shoulder that projects in relation to the second cutting edge. The second cutting edges are realized in a converging manner in the style of wire cutters. With respect to the first cutting edges, the pliers mouth is realized with a cutting edge that extends in a continuously rounded manner. The second cutting edges, which with respect to the cutting plane are offset to the first cutting edges and extend in a continuously straight manner, can only complete a cutting process once the pliers are completely closed. This cutting tool is less suitable for cutting multi-wire cables.

WO 2021/160 549 A1 discloses a pliers-like cutting tool, the cutting edges of which first come into a superimposed position on a radially outermost region during the course of closing the tool. A plurality of cutting regions, which respectively have their own curvature contour and altogether form an opening region, are formed radially inward in this first closing position. Identical cutting regions are formed on both tool legs. The cutting regions are separated from one another by pointed-tip-like connecting regions, wherein said pointed-tip-like connecting regions contribute to forming an outer edge of the opening contour in the aforementioned first closing position. Even though sound cutting of cables is achieved with this cutting tool, other preparatory or supplementary cutting processes such as initial incising or stripping practically cannot be carried out in a sensible manner with this cutting tool.

U.S. Pat. No. 1,520,529 A discloses pruning shears, in which an essentially linear cutting edge is in the aforementioned first closing position formed on the one pliers leg radially outside and radially inside to the first superimposed position. With respect to the aforementioned opening contour, a cutting edge of the other tool leg, which essentially extends in a continuously concave manner with slight curvature, lies against essentially linear cutting edge. A step-shaped transition, which extends in a convexly curved manner from the first to the second cutting edge and is also continuously realized in the form of a cutting edge, is formed on the one tool leg whereas a connecting region, which projects in a convexly rounded manner and in the aforementioned first closing position is in a superimposed position with the step-shaped transition of the first tool leg, is formed on the other tool leg. The pruning shears are hardly suitable for cutting through cables. With respect to cables, the shape of the cutting edges can lead to comparatively high cutting halves. The cutting mouth already is largely closed regarding the second cutting edges in the first closing position. Comparable prior art is also disclosed in U.S. Pat. No. 3,461,555 A.

With respect to further relevant prior art, we also refer to DE 297 033 08 U1, DE 195 064 57 C2 and DE 295 025 91 U1.

There is a need for a cutting tool that on the one hand makes it possible to favorably cut through a cable, particularly also a cable with a plurality of wires but, on the other hand, also allows an initial separation of the cable sheath independently of a complete cut and thereby an favorable stripping of a wire.

Based on the initially cited prior art, the invention aims to disclose a cutting tool that is favorably realized, in particular, in the form of a cable cutter and preferably can be ergonomically handled as conveniently as possible.

### SUMMARY OF THE INVENTION

According to a first inventive idea, the above-defined objective is potentially attained with a cutting tool, in which it is proposed that the first cutting edge of the first tool leg has two first and second cutting regions, which are successively arranged in the radial direction and transition into one another via a first pointed-tip-like connecting region, wherein the first pointed-tip-like connecting region forms part of the outer edge of the opening region in the first closing position, and in that a first radius, which originates on the pivot plane from the axis of rotation and, viewed against the closing direction, lies on the first pointed-tip-like connecting region from outside, extends through the shoulder approximately at a half height plotted on a perpendicular to a second radius running on the pivot plane, which touches the second cutting edge of the first tool leg at a lowest point viewed against the pivoting direction, wherein the perpendicular extends through a region of the shoulder that projects furthest in the pivoting direction.

The above-defined objective is potentially also attained in that the first and the second cutting edge of the first tool leg respectively have two first and second cutting regions that are successively arranged in the radial direction and transition into one another via a first and a second pointed-tip-like connecting region, wherein the pointed-tip-like connecting regions are respectively realized in the form of a convex transition that separates the first and second cutting regions, which are respectively realized with a concave outer edge, and in that a straight line placed against the outside of the pointed-tip-like connecting regions extends through the shoulder formed between the first and the second cutting edge, wherein a projecting dimension of the shoulder plotted perpendicular to the straight line corresponds to fourfold or more of the greatest depth of the area, spanned by the straight line, of the first cutting region of the second cutting edge, the depth being plotted by the straight line in the opposite direction perpendicular to the straight line.

A further possible solution to the objective can be given by in that the first cutting edge of the first tool leg comprises two first and second cutting regions successively arranged in the radial direction, which transition into each other via a first pointed-tip-like connecting region, and in that the shoulder, which is formed only on the first tool leg, is divided with regard to a radially outer section of a first t outer edge facing the second cutting edge, with reference to a fourth radius extending from the axis of rotation, which extends through the shoulder at an intersection point in the section related to the intersection approximately in the middle of a height of the shoulder, and which section extends about half of its extension or more along a tangent to the fourth radius at the intersection, wherein the height results from a measured dimension plotted at the intersection point respectively perpendicular to a first dimension point of the shoulder itself furthest away from the fourth radius in the closing direction and up to a second dimension point of the second cutting edge furthest away against the closing direction, and in that the outer edge in the section, as viewed from the intersection point in each case, transitions into a convex curvature to the first dimension point and into a concave curvature to the second dimension point.

As a result, the shoulder is steep but is also formed with a curved transition radially inwards and radially outwards. In particular, if the shoulder is also designed as a cutting edge throughout, as preferred, this results in the possibility of a favorable continuous cut regardless of the shoulder. Since the shoulder is also comparatively steep as a result, there is nevertheless a favorable separation in the first closing position between the first and second cutting edges or the remaining opening region.

Each of the proposed embodiments, but also, where applicable, a combination of only individual features of the proposed solutions, can achieve an improved cutting result if the cutting tool is favorably handled by the user, for example when cutting cables, and in particular, electrical cables. The subdivision of the cutting edge of the first tool leg in radial direction, in particular, results in the cutting regions successively formed transitioning into one another across the pointed-tip-like connecting region, results in an all-round closed cutting opening, in particular, when the opening region is delimited in the first closing position by the shoulder, in which a cable, even one of different sizes, can be completely inserted in terms of its circumference and then be favorably cut through the leading pointed-tip-like connecting region with a favorable initial separation. The relatively large shoulder due to the specified condition and simultaneously, a second cutting region of the first cutting edge rising radially outwards towards the shoulder allows a cable to be cut to be favorably picked up and cut through in a favorable force-balanced manner. In particular, the additional second cutting edges can also be used to make a favorable pre-separation of the cable with the same cutting tool.

Starting from the first closing position, only the second cutting edges on the cable, which extend radially outwards in relation to the shoulder, can also be used to make a first where applicable, or also only exclusive cut, thereby cutting radially from the outside without the cable as a whole running the risk of reaching the region of the first cutting edges and possibly being completely severed due to the shoulder. The comparatively high shoulder, i.e., one that projects far into the closing direction, closes off the region of the first cutting edges at an early stage, so to speak, during such a cutting process.

When cutting with the first cutting edges, the pointed-tip-like connecting region separating the concave outer edges of the cutting regions of the first cutting edge from each other can lead to an essentially pointed-tip-like cutting load and corresponding cutting of the workpiece to be cut, meaning the cable for example, during the course of the cutting movement, which punctual load caused by the pointed-tip-like connecting region during the course of the further cutting edge and closing movement on both sides, the cutting process continues essentially in the circumferential direction of the workpiece to be cut. In this way, a single cut can be favorably made across the circumference of the workpiece to be cut or in the direction of extension of the cutting edge, preferably, also in combination with the cutting edge of the other tool leg, a plurality of individual cuts, which can complement each other to form a total cut across the complete cross-section of the workpiece to be cut. This allows cuts to be made with a comparatively low cutting force. The given geometric assignment that a first radius extending from the axis of rotation on the pivot plane, thereby applying it to the first pointed-tip-like connecting region from the outside, extends through the shoulder at about half a height, results in the relatively large free extension of the shoulder in the closing direction, together with an increase also in the second cutting region of the first cutting edge towards the shoulder, preferably continuously up to a vertex or apex region of the shoulder.

The first and second cutting edges of the first and second cutting edges lie on the same cutting plane also together with the shoulder, which preferably also comprises an outer edge region formed as a cutting edge in part or across its circumference or across its entire circumference.

The further possible geometrical assignment, entailing that a straight line applied on the outside to the pointed-tip-like connecting regions of both the first and the second cutting edge of the first tool leg extends through the shoulder formed between the first and the second cutting edge and, thereby, a perpendicular projecting dimension, perpendicular to the straight line with respect to the shoulder, which indicates the distance of the shoulder to the straight line, and corresponds to a fourfold or more of the greatest depth of the first cutting region, spanned by the straight line, of the second cutting edge, the depth being plotted from the same straight line, additionally or alternatively describes the ratio of the relatively large shoulder to an indentation of the first cutting region of the second cutting edge. This embodiment also leads to the advantages of the cutting tool described here, which have already been mentioned.

The connecting regions can form roof-like or rounded, in particular, convex tips but alternatively also blunt tip regions with a straight surface for example.

A subdivision of one or the cutting edges of the first tool leg can also serve to offer different machining regions. For example, the concave first cutting region of the second cutting edges, which adjoins the second cutting region of the second cutting edge radially inwards, can be used as a stripping region in conjunction with the third cutting edge. The other concave designs of the cutting edges formed on one of the cutting edges of the first or second tool leg can also be used for stripping.

In addition to limiting the opening region in the first closing position in the region of the second cutting edge, the shoulder also provides a depth stop for a material to be cut in the region of the second cutting edge so that it cannot reach the region of the first cutting edge in the direction of radius inwards into the region of the first cutting edge during a desired machining in the region of the second cutting edge.

The embodiment of the shoulder results in a subdivision of the cutting mouth with reference to the axis of rotation in the radial direction of separate cutting zones. By spreading the handle sections of the cutting tool accordingly, the shoulder can be pivoted into a position in which it releases a passage between the radially outer cutting zone and the radially inner cutting zone so that the material to be cut can be inserted into the region of the first cutting edge of the first tool leg.

As a result of the selected geometries, for example, with regard to the shoulder height in relation to the greatest depth of the second cutting edge, a cutting tool has been created by means of which it is also possible to work with the radially outer second cutting edge, and, in particular, with the radially outer end region of the second cutting edge, in a more manageable manner without having to accept an unfavorably large leg width of the tool legs in the region of the handle sections. For example, this end region of the second cutting edge is used for cutting into or stripping a cable sheath (so called “nibbling”) or furthermore, for example, for stripping wires.

The first radius can extend through the shoulder at about half a height, where the proportion of the part of the perpendicular between the first radius and the furthest projecting region of the shoulder can correspond to about 40 to 60 percent of the total perpendicular between the second radius and the most projecting region of the shoulder.

The projecting dimension can also correspond to about 4 to 8 times, and furthermore, for example, to 4.5 to 6.5 times the greatest depth of the region of the second cutting edge plotted by the straight line connecting the connecting regions.

The features of the independent claims described above are of significance both in themselves as well as in any combination with each other, wherein, furthermore, features of an independent claim can be combined with the features of another independent claim or with features of a plurality of independent claims, moreover, also with only individual features of ne or a plurality of the other independent claims.

Further features of the invention are explained below, including in the figure description, often in their preferred assignment to the object of claim 1 and/or further independent claim 2 or to features of other claims. However, they may also be of significance in an assignment to only individual features of claim 1 and/or the further independent claim 2 or of the respective further claim, or in each case independently.

Thereby, in accordance with an embodiment, it can be provided that the first cutting edge across its entire length and the second cutting edge over substantially its entire length can be moved on top of each other with a third cutting edge of the second tool leg extending across a combined length of the first and second cutting edges.

The third cutting edge in the region of the second tool leg: is correspondingly preferentially designed for cutting interaction with both the first cutting edge as well as the second cutting edge of the first tool leg. During the course of the cutting-closing movement, the cutting edges of the first and second tool legs move over each other in a scissor-like manner.

In another favorable way, the projecting shoulder can only be formed (exclusively) on the first tool leg. This offers particular advantages with regard to the release of the radially inner cutting zone with the first cutting edge or the opening of the passage between the radially outer cutting zone and the radially inner cutting zone, as this requires a comparatively smaller spread of the handle sections compared to an arrangement in which both tool legs have a projecting shoulder. Such an asymmetrical embodiment of the tool legs with regard to their outer edge or cutting edge facing the cutting mouth is preferred.

The shoulder is an embodiment of the first tool leg, which is placed in a-first-layer on top of each other with the second tool leg, in this case with the cutting edge formed on it, in the first closing position. In the first closing position, a pointed-tip-like connecting section is either part of the remaining opening region or part of the free-opening, outward-extending second cutting edge of the first tool leg. With regard to one or a plurality of pointed-tip-like connecting sections of the cutting edge of the second tool leg, it follows in the same way that such a connecting region is either part of the opening region or is part of the part of the cutting edge extending freely outwards extending radially outwards towards the shoulder. In the closing position, furthermore, with regard to the second tool leg, a part of the cutting edge of the second tool leg extending essentially along a radius and preferably essentially straight is preferred, in the overlapping position to the shoulder.

In relation to a length of the third cutting edge plotted in a perpendicular projection at a third radius running on the pivot plane, a third pointed-tip-like connecting region can be formed in a first half of the length as viewed from the axis of rotation, which thus also forms part of the outer edge of the opening region in the first closing position. This third pointed-tip-like connecting region can be formed as a convex transition in accordance with the first connecting region of the first cutting edge described above, which separates the adjacent cutting regions of the third cutting edge, which are preferably formed with a concave outer edge. As a result of this further preferred embodiment, there is a supportive influence during the course of the cutting process in the region of the first cutting edge or the first cutting zone.

In a further embodiment, the embodiment of the third cutting edge can be made in such a way that the third radius extending from the axis of rotation on the pivot plane, which lies on the third pointed-tip-like connecting region from the outside, as viewed in the closing direction, does not extend through the second tool leg, i.e., in particular, the further region of the third cutting edge formed on it, beyond the third pointed-tip-like region. Rather, starting from the axis of rotation, such a radius, which preferentially tangents or touches the connecting region, runs freely in one direction radially outwards (depending on the closing position of the tool legs, where applicable, only extending through the first tool leg). Thus, furthermore, a cutting region of the third cutting edge adjoining the third connecting region radially outwards-as viewed from the first tool leg-runs continuously with a distance beyond the third radius, while the cutting region of the third cutting edge extending from the third connecting region radially inwards where applicable, for example in a radially inner end region of the outer edge limiting the opening region, the third radius can certainly intersect on the pivot plane.

The first pointed-tip-like connecting region and the third pointed-tip-like connecting region can be offset in the radial direction to each other. Preferably, this is chosen with regard to the measured dimension of movement in such a way that during the course of closing the opening region between the first cutting edge and the third cutting edge, the first and third connecting regions do not or do not travel significantly directly over each other. Accordingly, the pointed-tip-like first and third connecting regions are moved over circular paths with different radii during the course of the pivoting shift of the tool legs with reference to the axis of rotation. A workpiece picked up in the region of the first cutting edge for cutting or cutting, for example a cable, can therefore be cut at a higher speed in a radial direction, related to the axis of rotation, which contributes to a favorable cutting process.

In accordance with a preferred embodiment, it is further provided that the third pointed-tip-like connecting region of the third cutting edge is formed closer to the axis of rotation than the first pointed-tip-like connecting region of the first cutting edge. For example, a point of the first pointed-tip-like connecting region that projects furthest in the closing direction can move on a circular line, the radius of which can correspond to about 1.1 to 1.5 times, and furthermore, for example, about 1.25 times, of the radius over which the circular line of the point of the third pointed-tip-like connecting c region that projects furthest in the closing direction is defined.

a further embodiment, the radius dimension of the circular line, over which the third pointed-tip-like connecting region can be shifted, can correspond to about 0.4 to 0.6 times, and further about 0.5 times, of the circle line radius dimension along which the region or point of the shoulder that projects furthest in the closing direction is shifted.

The first and second cutting edges of the first tool leg can be formed as the outer edge of a first contact and support surface of the first tool leg. Furthermore, the third cutting edge of the second tool leg may also be formed as the outer edge of a second contact and support surface of the second tool leg, wherein the first contact and support surface has moved over or aligned with the second contact and support surface in the closing position. The first and second contact and support surfaces can each run on the same continuous plane. This continuous plane can be, as is also preferred, the pivot plane running perpendicular to the axis.

In further embodiment, the first portion of the first cutting edge and the first portion of the second cutting edge can extend (essentially) along the same second radius running on the pivot plane with respect to the axis of rotation. In the case of tangential contact between this second radius at the outer edge of the first portion of the first cutting edge or at the outer edge of the first portion of the second cutting edge, in relation to the other first portion of the other cutting edge, where applicable, there can be a distance to the other first portion, considered perpendicular to the second radius, which distance is preferably less than 1 mm, preferably smaller than 0.5 mm, such as 0.1 or 0.2 mm for example.

A length of the first cutting edge plotted on this second radius to a point of the first cutting edge that projects furthest in the closing direction can, in accordance with a further preferred embodiment, correspond to about twice or less of a projecting dimension of this point, perpendicular to the second radius. Furthermore, this most projecting point of the first cutting edge is formed by the most projecting point of the shoulder so that the shoulder can form part of the first cutting edge or part of the second cutting region of the first cutting edge corresponding to the first, radially inner cutting zone.

The cutting edge of the second tool leg, the third cutting edge, also preferentially runs along its entire radial length in the same plane, i.e., practically the pivot plane. This then also corresponds to the cutting plane.

In a further embodiment, the first contact and support surface of the first tool leg can be formed continuously, including the shoulder, with a cutting edge comprising a cutting angle. Thereby, the shoulder is still preferably part of the first and/or second cutting edge of the first tool leg, in this respect, it is still preferred with regard to the flanks of the shoulder that run approximately in the direction of the shoulder but also run circumferentially.

The cutting angle may vary over the length of the first and/or second cutting edge of the first tool leg. Thus, in the immediate region of the embodiment of the first cutting edge and/or second cutting edge, there can be a usual cutting angle of about 20 to about 40°, furthermore, for example, about 35°, in addition, preferably also in the flank region of the shoulder facing the first cutting edge, whereas further, for example, the flank region of the shoulder facing the second cutting edge has a larger cutting angle of e.g., 75 to 88°, can also be about 85°, for example.

The ranges or value ranges or multiple ranges specified above and below also include all intermediate values with regard to the disclosure, in particular in 1/10 steps of the respective dimension, i.e., where applicable, also dimensionless. For example, the indication 20 to 40° also includes the disclosure from 20.1 to 40°, 20 to 39.9°, 20.1 to 39.9°, etc., the disclosure from 4 to 8 times, also the disclosure from 4.1 to 8 times, 4 to 7.9 times, 4.1 to 7.9 times, etc. This disclosure can serve on the one hand to limit a specified region boundary from below and/or above, but alternatively or additionally it can also serve to disclose one or a plurality of singular values from a respective specified region.

### BRIEF DESCRIPTION OF THE DRAWINGS

The invention is explained below on the basis of the attached drawing, which, however, depict only an exemplary embodiment. The drawing shows:

FIG. 1 the cutting tool in perspective illustration, concerning the closing position of a cutting mouth;

FIG. 2 the cutting tool in a lateral view in accordance with arrow 11 in FIG. 3;

FIG. 3 the cutting tool in a further lateral view in accordance with arrow III in FIG. 2;

FIG. 4 the cutting tool in a further lateral view in accordance with arrow IV in FIG. 3;

FIG. 5 the cutting tool in view in accordance with arrow V in FIG. 4;

FIG. 6 the cutting tool in a top view;

FIG. 7 the cutting tool in a bottom view;

FIG. 8 the section in accordance with line VIII-VIII in FIG. 3;

FIG. 9 the cutting tool in a view in accordance with FIG. 3 when using a first cutting region of a second cutting edge;

FIG. 10 the enlarged illustration of region X in FIG. 9;

FIG. 11 an illustration essentially equivalent to FIG. 9, but with the use of a second cutting region of the second cutting edge;

FIG. 12 the enlargement of region XII in FIG. 11;

FIG. 13 a further illustration essentially corresponding to FIG. 9, but with the use of a first cutting edge of the cutting tool;

FIG. 14 the enlargement of region XIV in FIG. 13;

FIG. 15 in another illustration essentially corresponding to FIG. 9, an alternative use of the first cutting edge of the cutting tool;

FIG. 16 the enlarged illustration of the region XVI in FIG. 15;

FIG. 17 the enlarged region XVII in FIG. 3;

FIG. 18 an illustration essentially the same as FIG. 17 but concerning a first closing position of the cutting tool;

FIG. 19 in an enlarged individual illustration, a first tool leg of the cutting tool with a first cutting edge and a second cutting edge as well as a shoulder formed between the cutting edges;

FIG. 20 the further enlarged illustration of region XX in FIG. 19;

FIG. 21 in an enlarged individual illustration, a second tool leg of the cutting tool with a third cutting edge;

FIG. 22 the section in accordance with line XXII-XXII in FIG. 17;

FIG. 23 the section in accordance with line XXIII-XXIII in FIG. 17;

FIG. 24-30 the cutting tool in further views; and

FIG. 31 a further illustration in accordance with FIG. 19, to explain a further characterization of the cutting mouth with regard to the shoulder.

### DESCRIPTION OF THE EMBODIMENTS

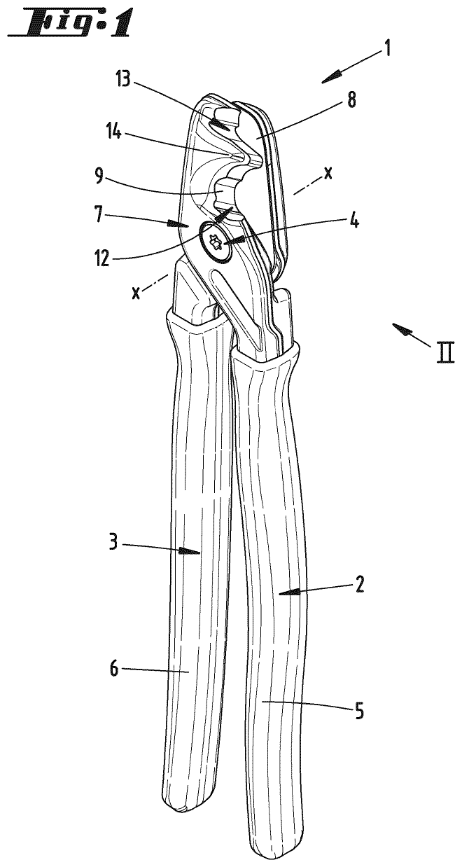

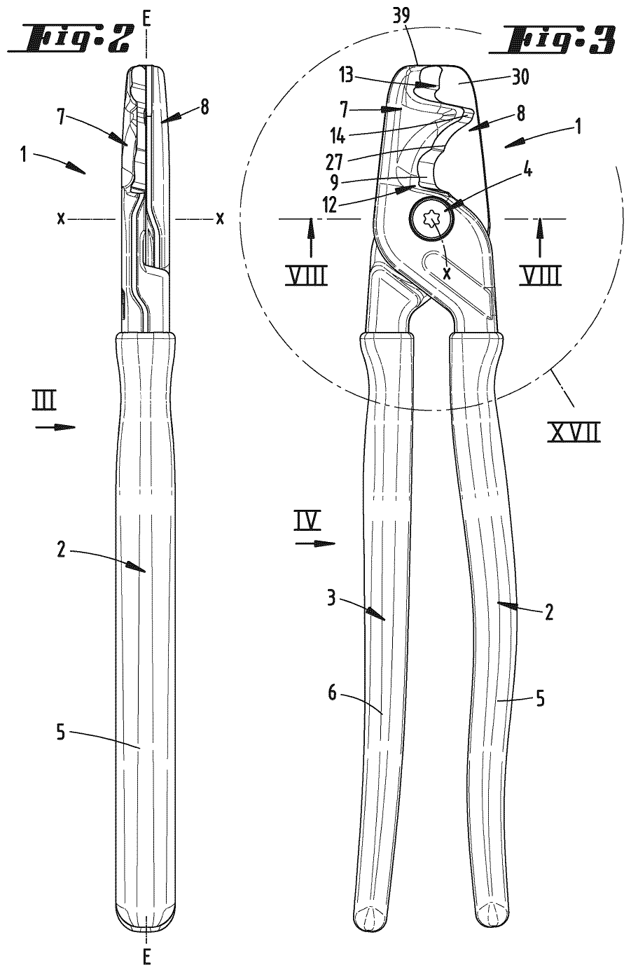

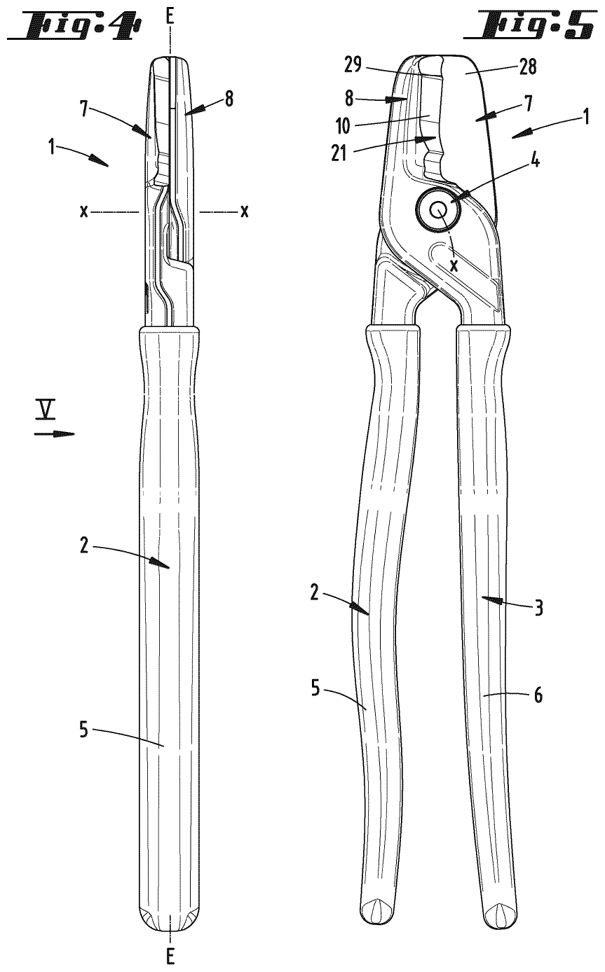

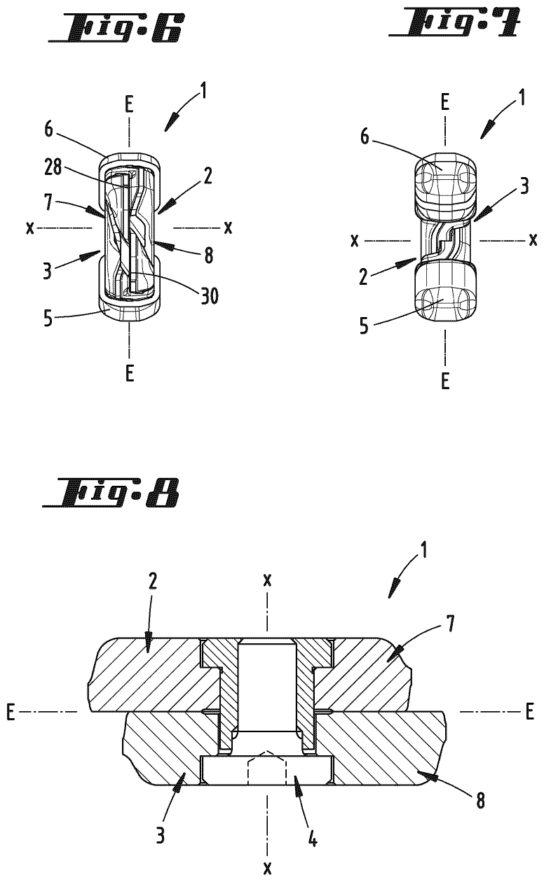

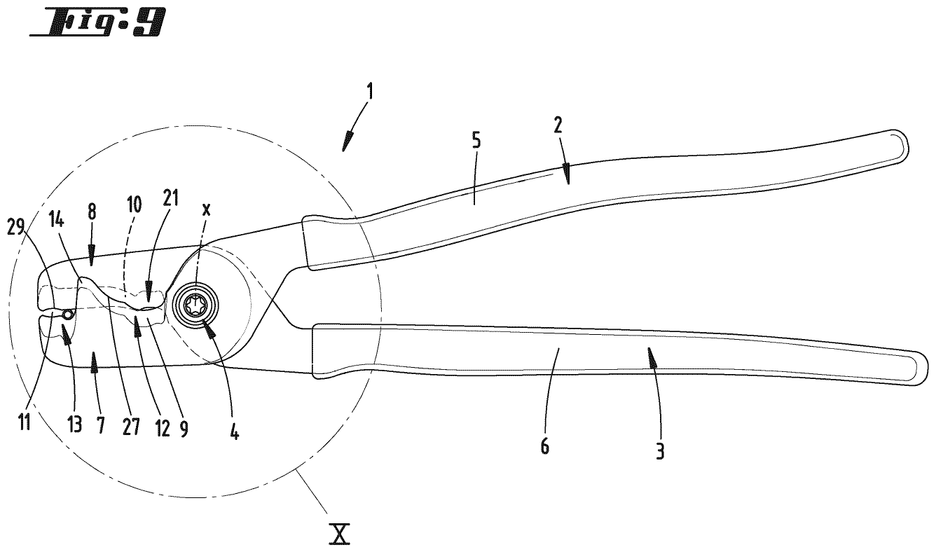

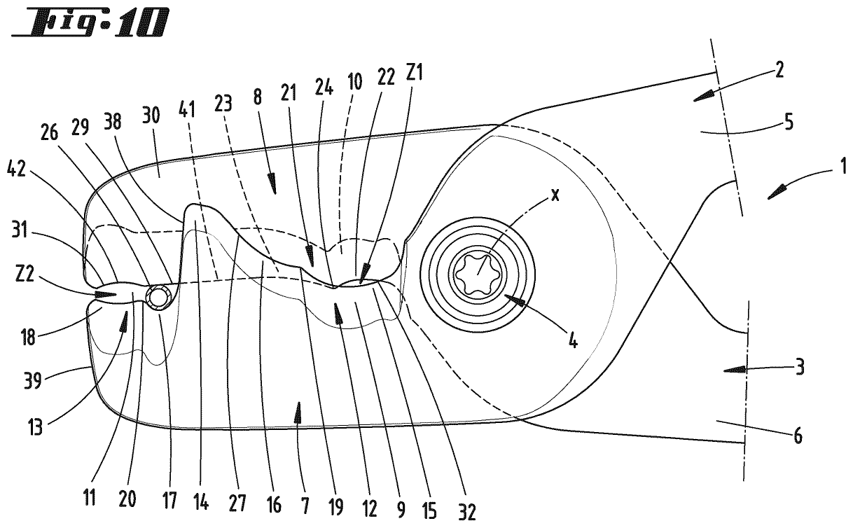

Shown and described, first with reference to FIGS. 1 to 7, is a manually operable cutting tool 1, here, as is also preferred, in the form of a cable cutter with a first tool leg 2 and a second tool leg 3, which tool legs 2 and 3 cross each other in a pivot bolt 4 (joint) and can thus be pivoted towards each other around a geometric axis of rotation x formed by the pivot bolt 4 in a pivot plane E. The axis of rotation x is preferably aligned perpendicular to the pivot plane E.

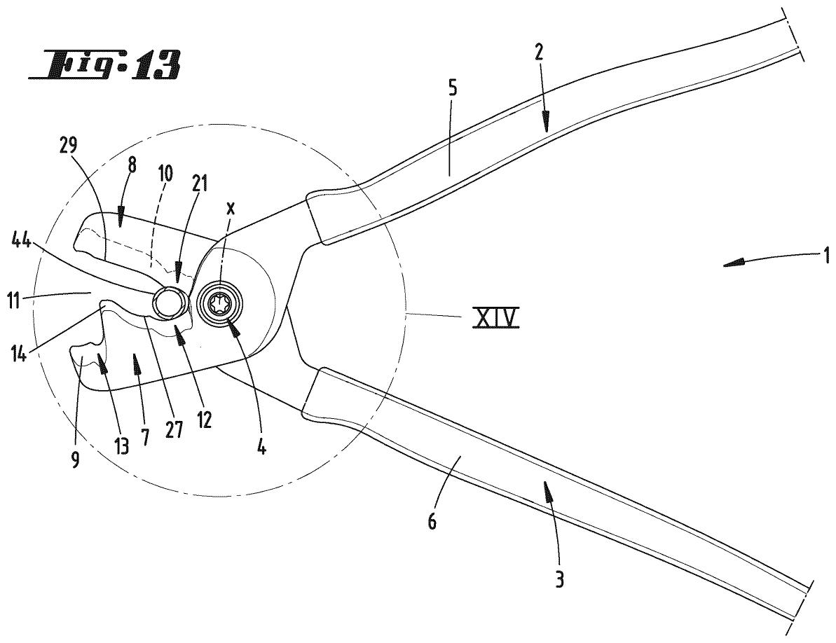

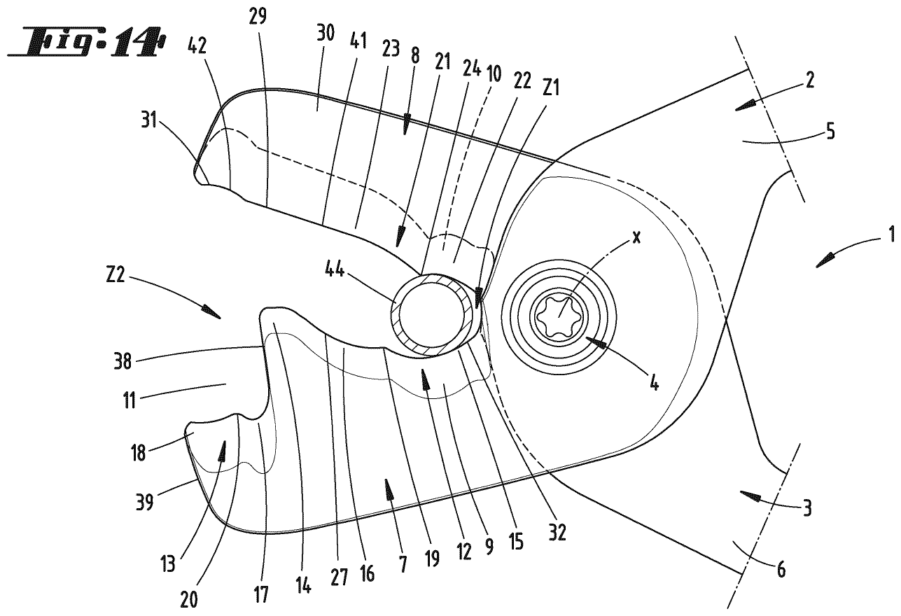

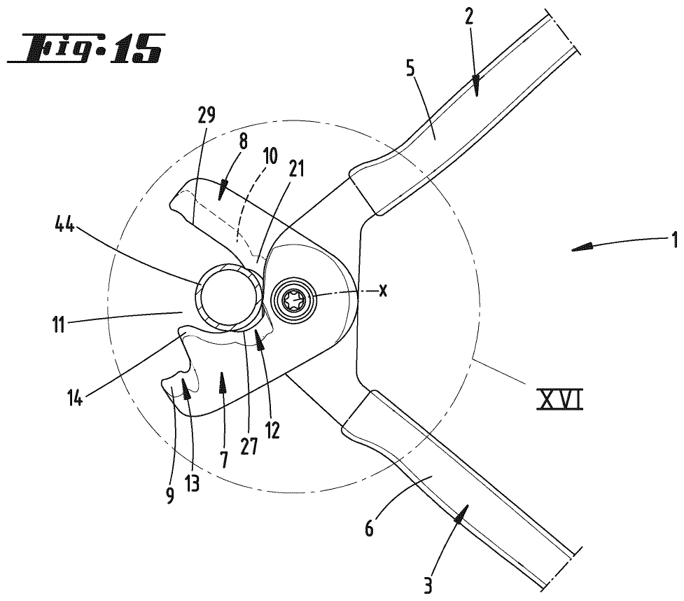

Each tool leg 2 and 3 forms a handle section 5 or 6 on one side of the pivot bolt 4 and cutting jaws 7 or 8 on the other side of the pivot bolt 4. The cutting jaws 7 and 8 with their working surfaces 9 and 10 limit a cutting wall, at least in an open position, for example, in accordance with FIG. 14. Working surfaces 9 and 10 are essentially designed as cutting edges, as will be explained below, or consistently designed as such.

In the case of a preference for the essentially at least approximately symmetrical embodiment of the tool legs 2 and 3, and in particular with regard to the design of the handle sections 5 and 6 and the outer contour of the cutting jaws 7 and 8, an asymmetrical design is preferred, particularly with regard to the working surfaces 9 and 10 of the cutting jaws 7 and 8. The working surface 7 of the first tool leg 2 is preferably formed differently from the working surface 8 of the second tool leg 3. In this embodiment, the tool legs cannot be transitioned into each other by rotating around their longitudinal axis.

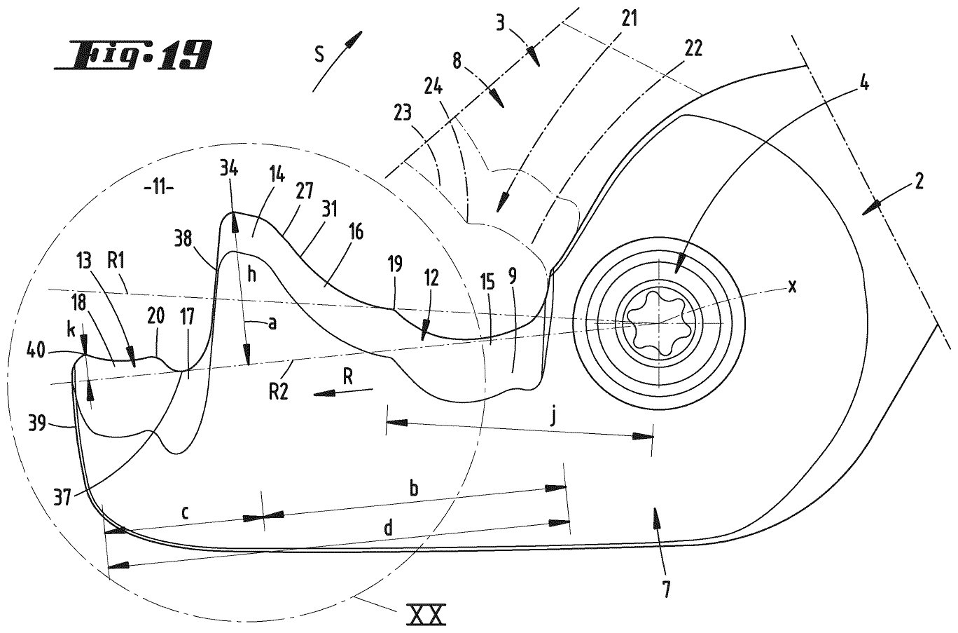

Thereby, as can also be seen in particular from the individual illustration in FIG. 19, the cutting jaw 7 of the first tool leg 2 is provided with two cutting edges arranged in succession in the radial direction R in relation to the axis of rotation x, such as a radially inner first cutting edge 12 and a radially outer second cutting edge 13, wherein the first cutting edge 12, at the transition to the second cutting edge 13, transitions into a projecting shoulder 14 in a closing direction S of the cutting tool 1, in particular with regard to the second cutting edge 13.

Both cutting edges 12 and 13 are preferably divided into two cutting regions successively arranged in the radial direction R, so the first cutting edge 12 is divided into a first cutting region 15 and a second cutting region 16 and preferably, the second cutting edge 13 is divided into a first cutting region 17 and a second cutting region 18. The cutting regions 15 and 16 each transition into each other via a first pointed-tip-like connecting region 19 and the cutting regions 17 and 18 preferably via a second pointed-tip-like connecting region 20.

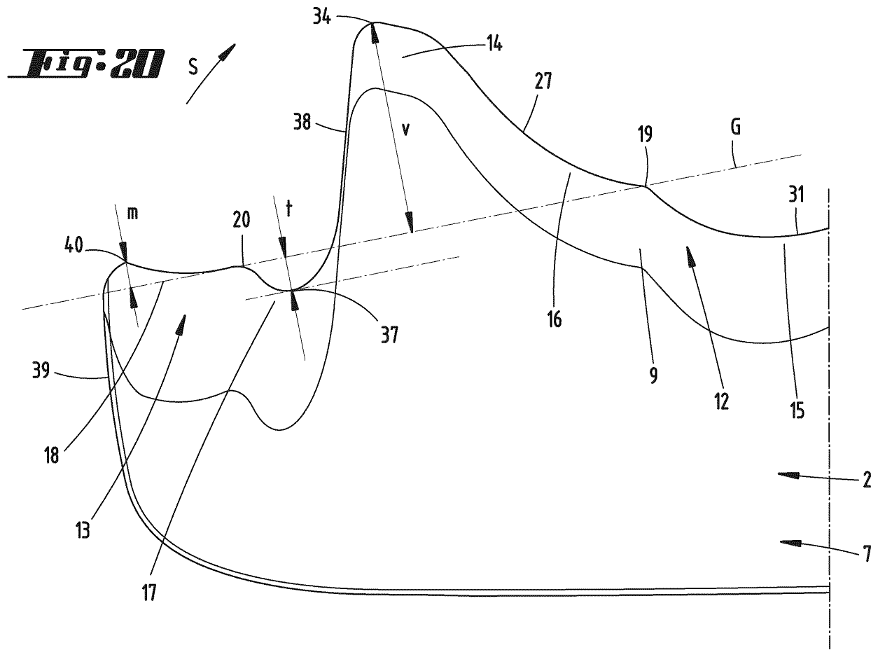

The cutting jaw 8 of the second tool leg 3, on the other hand, is preferably provided with only one cutting edge (third cutting edge) 21, which, as viewed in the radial direction R, is essentially divided into a first cutting region 22 and a second cutting region 23, which cutting regions 22 and 23 preferably, and also preferably only to transition into each other via a third pointed-tip-like connecting region 24 (see also detailed illustration in FIG. 21).

The pointed-tip-like connecting regions 19, 20 and 24 are essentially each formed as a convex curved transition considered in (the respectively) closing direction S, at which concave curved cutting regions are connected on both sides, also viewed in the closing direction S. Accordingly, the connecting regions are projecting at the top in relation to the immediately adjoining cutting regions in the closing direction S in a pointed-tip manner so that the cutting regions on both sides are separated by the connecting regions.

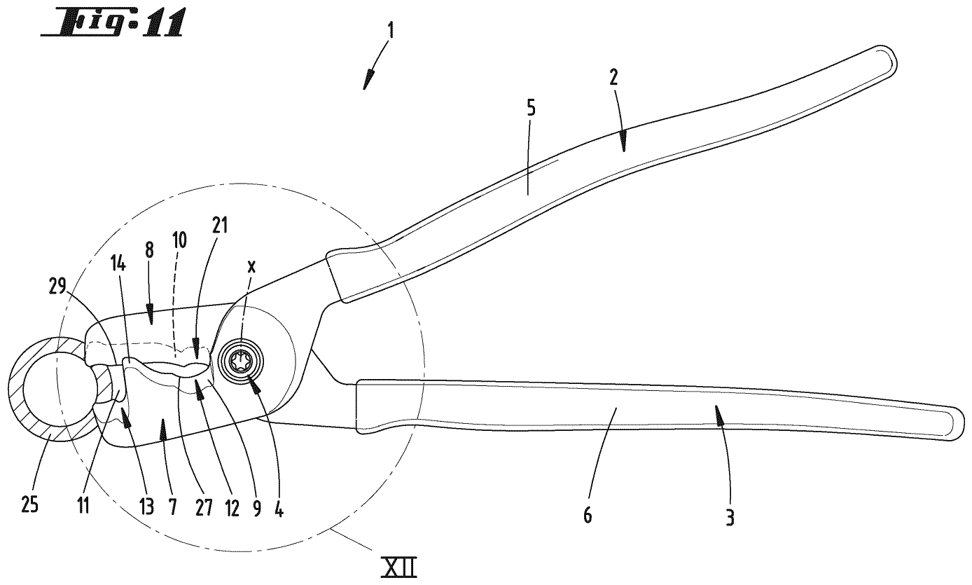

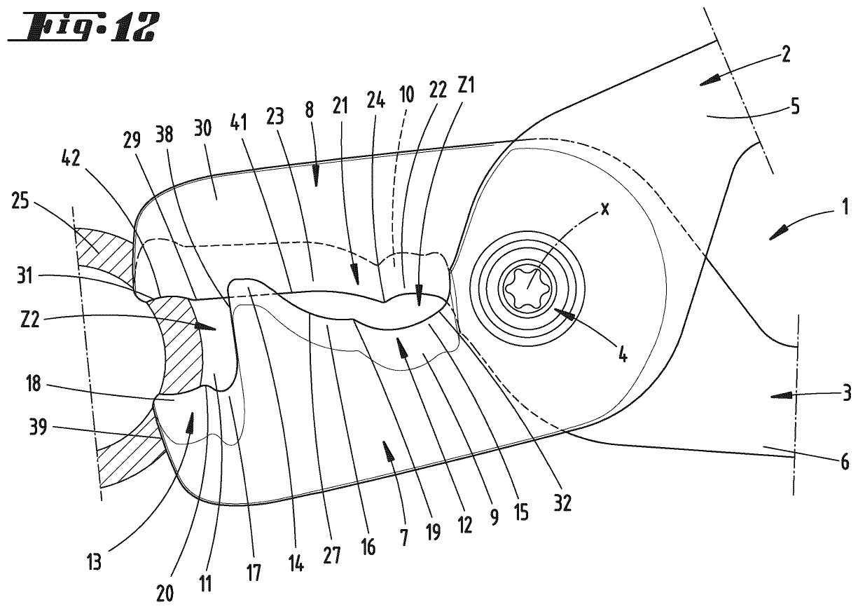

This enables the user to use one or the other cutting region in a targeted manner, for example in the region of the second cutting edge 13, where the radially outer second cutting region 18, for example in accordance with the illustrations in FIGS. 11 and 12, can be used preferably, for example for cutting a cable sheath 25, while further, for example, the radially inner first cutting region 17 of this second cutting edge 13 is used in a targeted manner can be, for example, for stripping a wire 26 (see FIGS. 9 and 10).

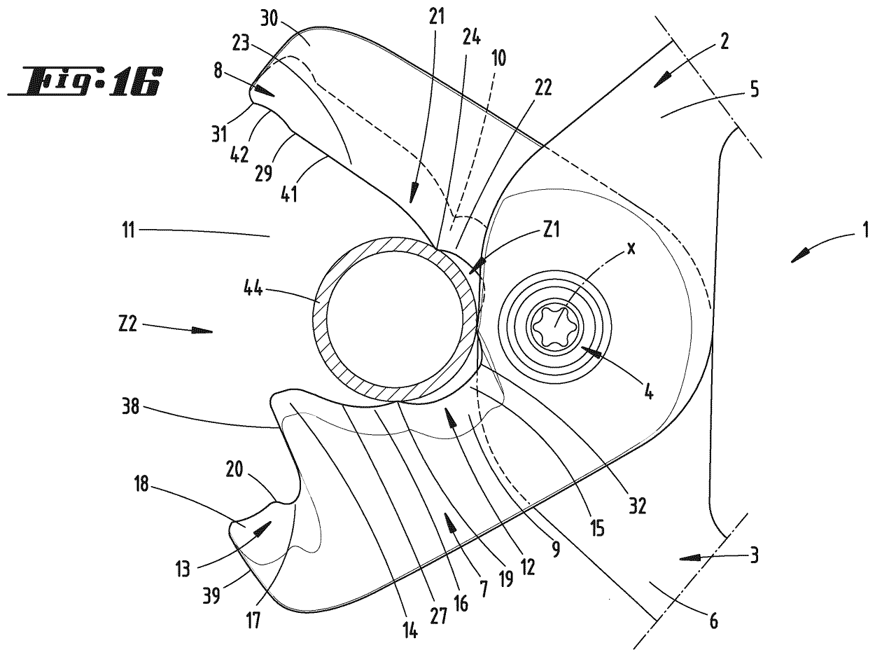

In addition, the cutting regions separated by the connecting region may also be used in combination, in particular for cutting through cables 44 of different diameters (cf. FIGS. 13 to 16), and in particular with regard to the cutting regions 15 and 16 of the radially inner first cutting edge 12 of the first tool leg 2.

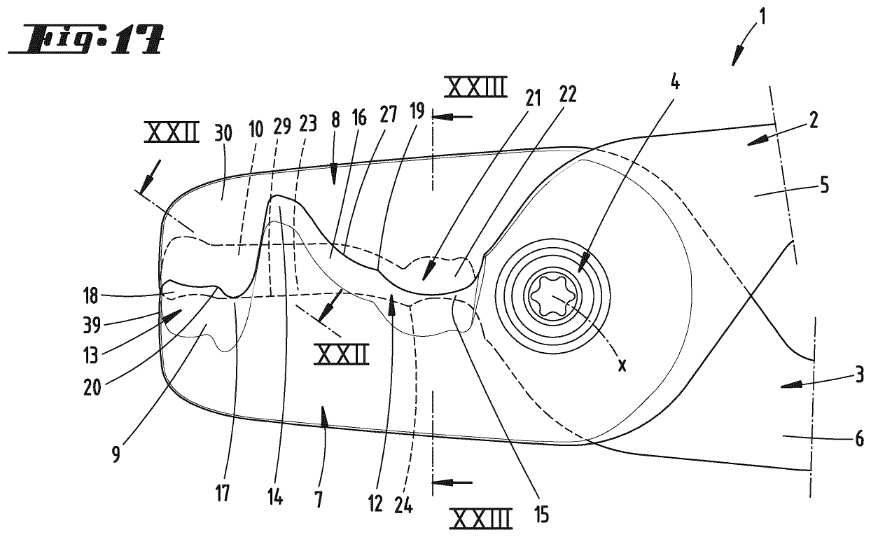

The first cutting edge 12, together with the second cutting edge 13 and the shoulder 14, forms a first outer edge 27 bounding the cutting mouth, which simultaneously forms the boundary of a first contact and support surface 28 of the first tool leg 2 in the region of the cutting jaw 7, which is facing the opposite tool leg 3 and extends in a pivot plane E. The second outer edge 29, which further limits the cutting mouth, is formed by the third cutting edge 21 of the second tool leg 3. Here, too, this outer edge 29 also forms a boundary of a second contact and support surface 30 of the second tool leg in the region of the cutting jaw 8, which extends correspondingly also on the pivot plane E. Both contact and support surfaces 28 and 29 rest on each other at least in one closing position, for example in accordance with FIG. 17, with the relevant outer edges 27 and 29 moving over each other, wherein the contact and support surfaces 28 and 30 continue to run practically in the same plane, the pivot plane E. In the closing position, the first contact and support surface 28 is moved over each other at different distances in the radial direction with the second contact and support surface 30, but preferably only over part of the respective region.

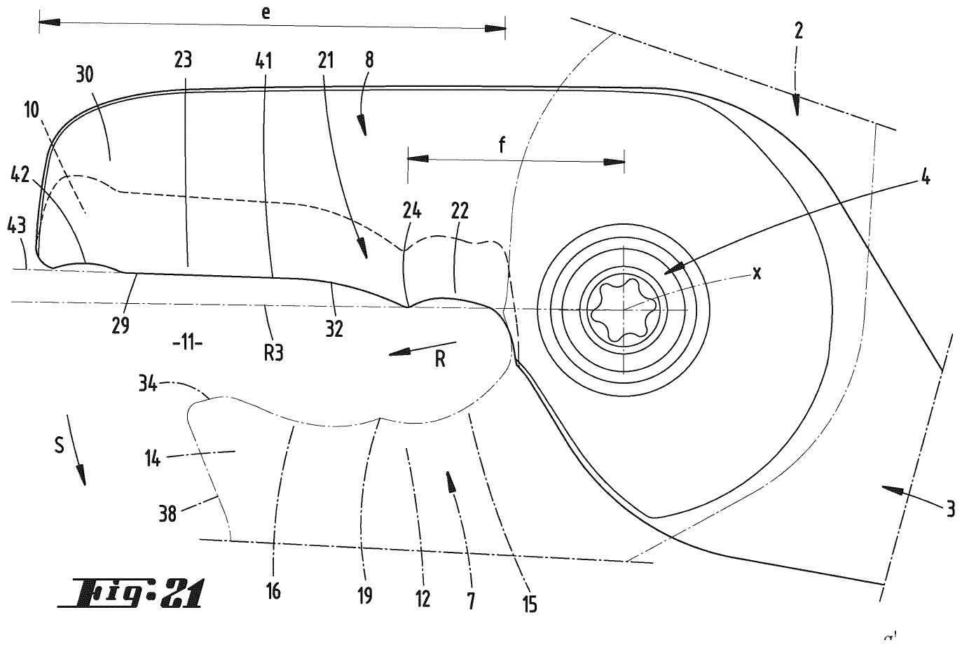

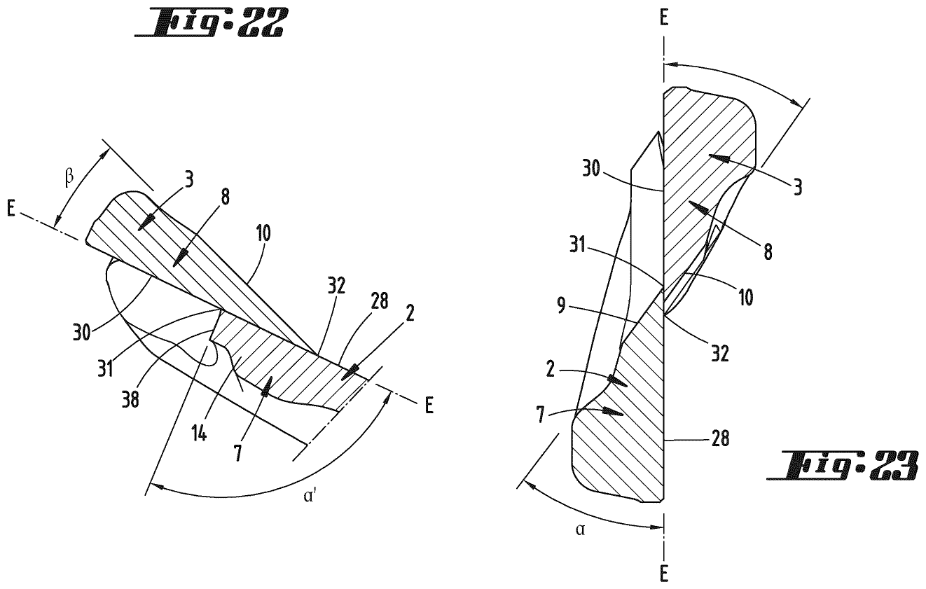

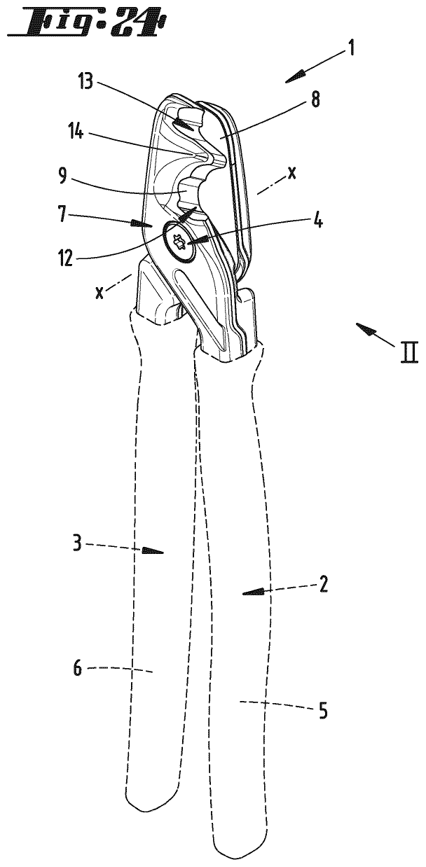

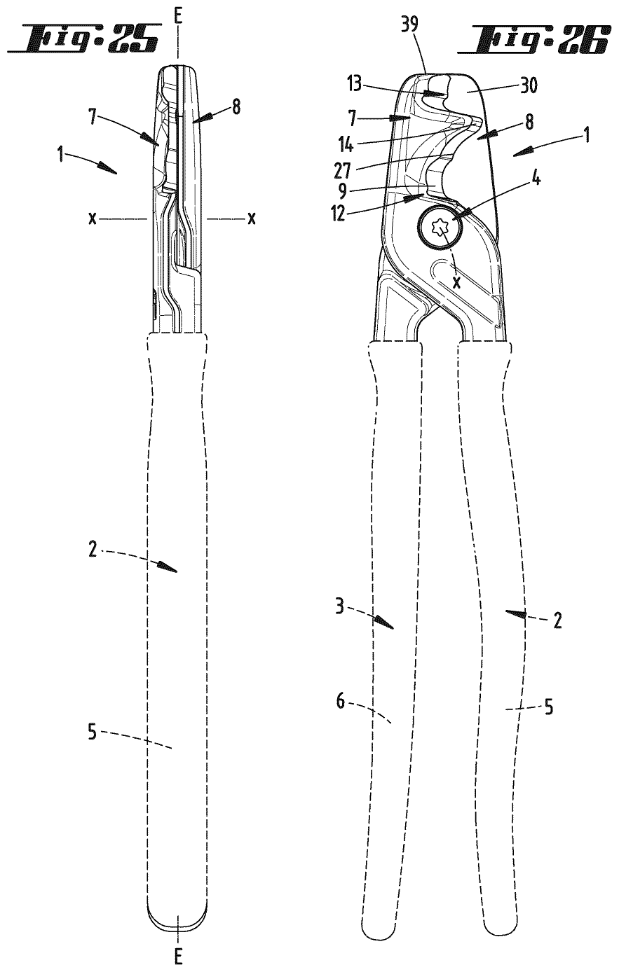

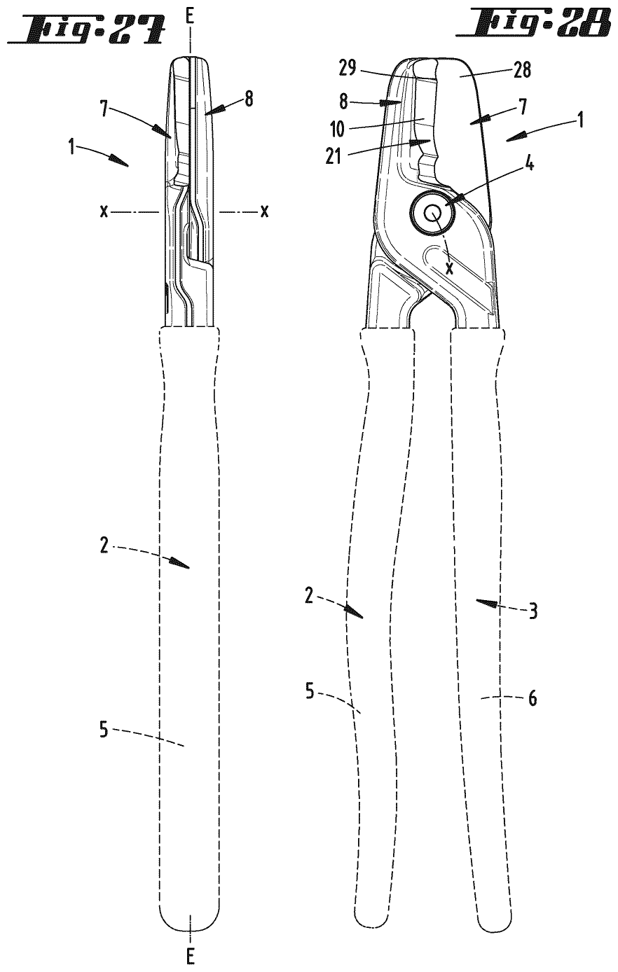

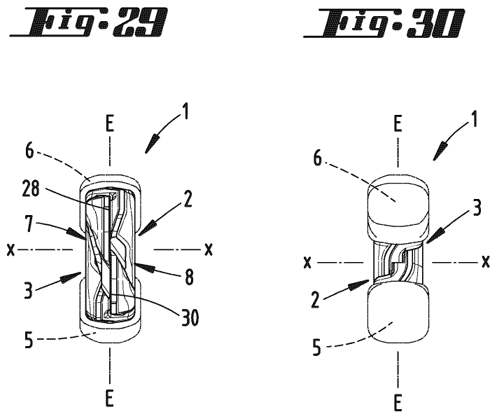

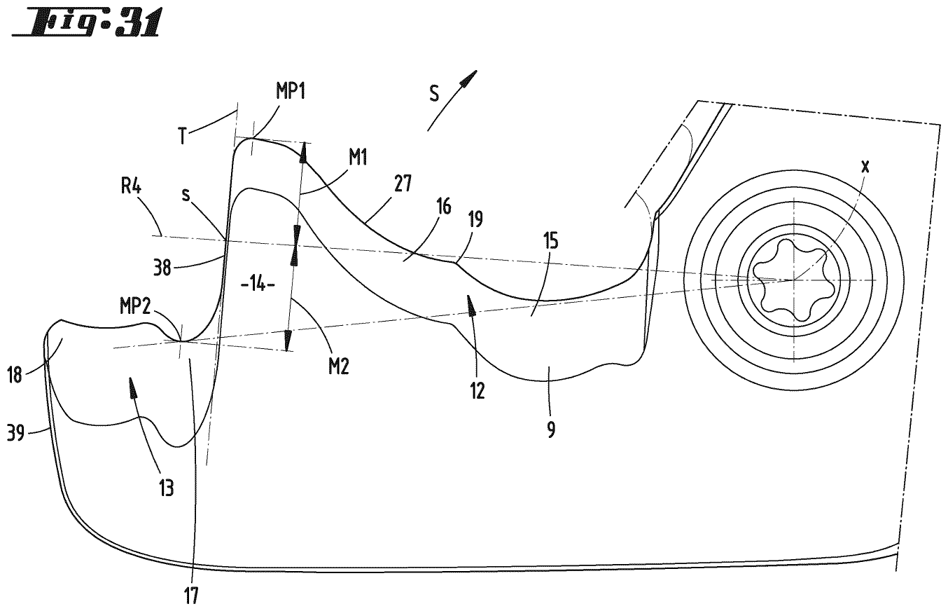

The first contact and support surface 28 of the first tool leg 2 is continuously provided with a cutting edge 31 having a cutting angle α, including the first cutting edge 12, the second cutting edge 13 and the shoulder 14, as well as the second contact and support surface 30 with a cutting edge 32 having a cutting angle β (cf. FIGS. 22 and 23). Thus, the shoulder 14, which separates the first cutting edge 12 from the second cutting edge 13, can also be formed with a cutting edge along its outer edge freely circumferentially running between the cutting edges 12 and 13, which forms a section of the first outer edge 27, wherein further facing the first cutting edge 12, the corresponding outer edge of shoulder 13 is formed as a cutting edge 31 with essentially the same cutting angle α of, for example, about 20 to 40°, furthermore, for example, about 35°, as in the region of the first cutting edge 12, while, preferably, a radially outer section of the first outer edge 27 or the shoulder flank 38 in accordance with cross-sectional FIG. 22 facing the second cutting edge 13 can moreover comprise a cutting angle α′ of, 80 to 85°, for example, compared to the usual cutting angle α of about 20 to 40°, up to 89° where applicable.

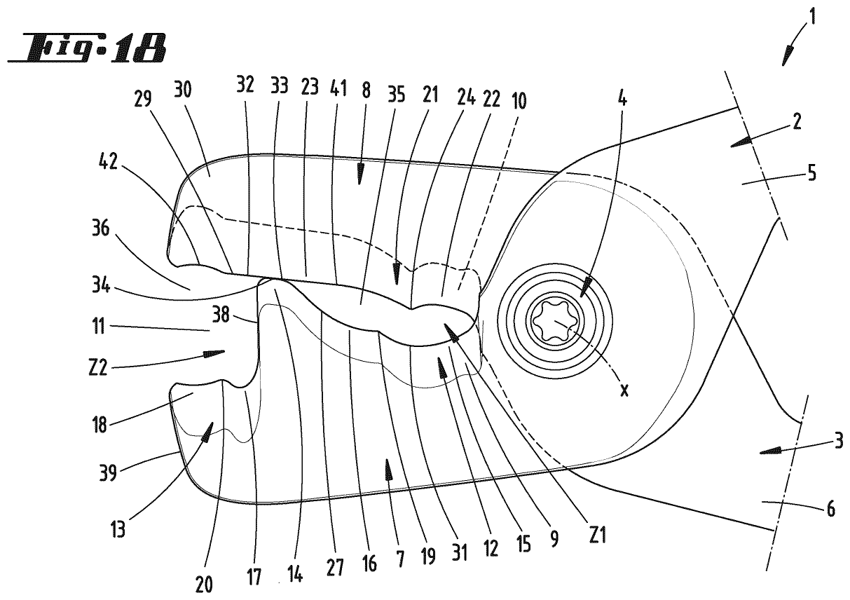

During the course of the swivel displacement of the tool legs 2 and 3 relative to each other in the closing direction S, a first closing position results in which the shoulder 14 of the first tool leg 1 comes for the first time in a closing region 33 in a position on top of each other to the second tool leg 3, in this case in particular to the third cutting edge 21 (see FIG. 18). This closing region 33 can be defined, as is also preferred, by a region 34 of the shoulder 14 which is most projecting in the closing direction S, wherein, in a view in accordance with FIG. 18, in which view this axis of rotation x is shown as a point, this region 34 can appear to be pointed-tip-like, or also, as indicated in FIG. 18, shown by a straight section running essentially in the radial direction with reference to the axis of rotation x.

In this first closing direction in accordance with FIG. 18, between the first cutting edge 12 of the first tool leg 2 and the third cutting edge 21 25 of the second tool leg 3, there remains a first opening region 35 which is circumferentially closed by the outer edges 27 and 29 of the cutting edges 12 and 21. The closing region 33 results in this first closing position in radial direction R when viewed from the axis of rotation x at a radial end of the opening region 35.

As can be seen further from the illustration in FIG. 18, in this first closing position of the cutting tool 1, between the second cutting edge 13 of the first tool leg 1 and the section of the third cutting edge 21 of the second tool leg 3 projecting radially outwards via the closing region 33, there is a second opening region 36 that is still open radially outwards.

As can be seen from the detailed illustration in FIG. 19, a first radius R1 originating from the axis of rotation x, which is lies on the first pointed-tip-like connecting region 19 of the first cutting edge 12, as viewed from the outside, against the closing direction S, extends through the region of the second cutting region 16 of the first cutting edge 12 adjoining the first connecting region 19 as well as the shoulder 14 adjoining it, in order to exit freely outwards in the region of the steeply sloping flank 38 of shoulder 14 running into the first cutting region 17 of the second cutting edge 13 with regard to the first tool leg 2 alone. In this case, the first radius R1 spans the concave outer edge section of the first cutting region 15 of the first cutting edge 12 in a tendon-like manner.

The first outer edge R1 extends through the shoulder 14 in the region of about half a height h, which height h is plotted along a perpendicular α, which is located between the region 34 that perpendicular furthest in the closing direction S, depending on a progression of the outer edge of the shoulder, it can also be a point, the shoulder 14 and a second radius R2, which the second cutting edge 13 of the first tool leg 2 touches at a lowest point 37 as viewed in the opposite direction of the pivoting direction S. The perpendicular a refers to the second radius R2. The lowest point 37 is still preferably found in the area of the first cutting region 17 of the second cutting edge 13.

As can be seen further from the illustration in FIG. 19, the second radius R2 can, in addition to the contact at point 37 in the region of the second cutting edge 13, simultaneously essentially also essentially affect the first cutting edge 12 in the area of the first cutting region 15, where applicable with a comparatively small distance of preferably less than 1 mm, so on, preferably from a few tenths of a millimeter, for example, from 0.2 or 0.3 mm to an applied tangent.

The second radius R2 runs further, preferably starting from the axis of rotation x completely to the exit in the region of a front surface 39 of the first tool leg 2, completely extending through the tool leg 2 or the cutting jaw 7. Starting from the axis of rotation x, the second radius R2 preferably exits only in the region of the front surface 39.

Starting from the lowest point 37 of the second cutting edge 13 in the area of the first cutting region 17, there is a distance to the second radius R2 described above with regard to the further course of the second cutting edge 13, particularly with regard to the second cutting region 18 and the second connecting region 20 so that with reference to a highest point 40 of the second cutting edge considered in the closing direction S, which is here a highest point of the second cutting region 18 of the second cutting edge 13, along a perpendicular to the radius R2 can set a height which can correspond to about 1/10 to ¼, furthermore, for example, about ⅙ of the above-described height h of the shoulder 14 starting from the same second radius R2.

Essentially starting from the most projecting region 34 of the shoulder 14, a length b of the first cutting edge 12 and a length c of the second cutting edge 13 result along a radius, which length c can correspond to about 0.4 to 0.7 times, and further, for example, about 0.5 to 0.6 times the length b of the first cutting edge 12. This results in a summarized length d at the cutting edges 12 and 13, which length d essentially corresponds to the total length e of the third cutting edge 21, which is also considered in the radial direction. In addition, the length b of the first cutting edge 12 can correspond, as is also preferred, to about 1.5 to 2 times the projecting dimension considered perpendicular to the second radius R2 or the height h in the region of shoulder 14.

In the enlarged cut-out illustration of the first tool leg 2 in FIG. 20, a straight line G is depicted, which, when viewed against the closing direction S, lies on the pointed-tip-like connecting regions 19 and 20 of the first and second cutting edges 12, 13, preferably touching the connecting regions in a pointed-tip-like manner. The straight line G extends through the shoulder 14 and spans the concave outer edge section of the first cutting region 17 of the second cutting edge 13 in a tendon-like manner in order to then again plunge into the cutting jaw 7 and exit at the end in the region of the front surface 39.

This results in a projecting dimension v of the shoulder 14 plotted perpendicular to the straight line G between the straight line G and the furthest projecting region 34 of the shoulder 14 or a furthest projecting point of the first cutting edge 12, which furthest projecting point of the first cutting edge 12 can be formed by the region 34 of the shoulder 14. This projecting dimension V can correspond to a maximum depth t fourfold or more, for example, up to 5 or 6 times, which is the greatest depth t in the opposite direction to the projecting dimension v starting from the straight line G in the spanned first cutting region 17 of the second cutting edge 13 at point 37 (cf. FIG. 20). A height dimension m carried in the direction of the projecting dimension v from the straight line in the region of the highest point 40 of the second cutting edge 13 can further correspond to about 1/10 to ⅕, and furthermore, for example, about ⅙ of the projecting dimension v.

A third radius R3 also originating from the axis of rotation x (cf. e.g., FIG. 21), which, when viewed in the opposite closing direction S of the second tool leg 3, lies on the third connecting region 24, can run radially outwards beyond this third connecting region 24 with respect to the second tool leg 3, i.e., no longer extending through the tool leg 3.

The third connecting region 24 with reference to the length e of the third cutting edge 21 is preferably arranged in a first half of length e—viewed from the axis of rotation x—and further preferably in a first quarter to a first third of length e.

In a further preferred embodiment, the pointed-tip-like connecting regions 19 and 24 of the first cutting edge 12 and the third cutting edge 21 are offset from each other when viewed in the radial direction R, wherein the third pointed-tip-like connecting region 24 is further preferably formed closer to the axis of rotation x than the first connecting region 19. Thus, in accordance with the illustrations in FIGS. 19 and 21, a radius dimension f of the third connecting region 24 can be obtained in this respect, which can correspond to about 0.6 to 0.9 times, and furthermore, for example, about 0.7 to 0.8 times the radius dimension j of the first connecting region 19.

In a further embodiment, the third cutting edge 21 in the region of its second cutting region 23 may initially have a concave section radially outwards from the third connecting region 24 that transitions into an essentially rectilinear section 41. In the region of the radially outer end of this rectilinear section 41, a further concave section 42 may follow, which ends radially in a line 43 that is thought to extend beyond the rectilinear section 41 (cf., in particular, FIG. 21).

In accordance with the proposed embodiment, there are in particular two cutting zones Z1 and Z2, which are essentially separated from each other by the projecting shoulder 14, wherein cutting zone Z1 results between the first cutting edge 12 of the first tool leg 2 and the section of the third cutting edge 21 of the second tool leg 3 having the third connecting region 24, and the second cutting zone Z2 between the second cutting edge 13 of the first tool leg 2 and the radially outer section of the third cutting edge 21 of the second tool leg 3.

The cutting zone Z1 is particularly suitable for cutting cables of 44 different diameters. The comparatively long handle sections 5 and 6 provide a favorable transmission and effect n the cutting edges, wherein due to the subdivision of the first cutting edge 12, in particular, into two cutting regions 15 and 16, which transition into each other via the first connecting region 19, and further due to the embodiment of the third connecting region 24 with cutting regions 22 and 23 of the third cutting edge 21 adjoining on both sides, a favorable cutting effect on the cable 44 is achieved. The pointed-tip-like connecting regions 19 and 24, which separate the concave cutting regions from each other, lead, where applicable, only in isolated cases, during the course of the cutting movement essentially to an initially pointed-tip-like cutting load on the workpiece to be cut, from which pointed-tip-like load through the connecting regions during the course Of the further cutting tool closing movement on both sides increasingly continues the cutting process essentially in the circumferential direction of the workpiece to be cut becomes. Furthermore, the preferred embodiment results in a favorable cutting sequence, wherein the opening region, which is limited on one side by the outer edge of the first cutting region 22 of the third cutting edge 21, finally reaches 12 in a superimposed position on top of the opposite cutting edge. In addition, as a result of this embodiment of the first cutting zone Z1, an effect can be achieved on the workpiece to be cut, for example cable 44, in which this workpiece to be cut tends to be loaded within the cutting opening in the direction of the axis of rotation during the course of the cutting process, preferably over the entire cutting process (at least from reaching the first closing point described). This intended effect also leads to an improved cutting pattern as well as favorable, force-reducing handling.

As mentioned above, the radially outer second cutting zone Z2 is preferably used, for example, for the cutting of a cable sheath 25 (cf. FIGS. 11 and 12), for which the radially outer cutting regions of the second cutting edge 13 and the third cutting edge 21 are used in particular, in particular the second cutting region 18 of the second cutting edge 13 and the concave section 42 of the second cutting region 23 of the third cutting edge 21. The first cutting region 17 of the second cutting edge 13, in combination with the straight section 41 of the second cutting region 23 of the third cutting edge 21, can be used, for example, to strip wires 26, as shown for example in FIGS. 9 and 10.

When using the second cutting zone Z2, shoulder 14 offers a stop radially inwards so that the cable to be processed or the wire to be processed does not get into the radially inner region of the cutting zone Z1.

Due to the geometry of the cutting edges described above, small leg widths result in workpiece processing in the region of the front cutting zone 22 with regard to handle sections 5 and 6 so that ergonomically favorable handling results in this respect.

With reference to FIG. 31, a further geometric relationship 10 is explained with regard to shoulder 14, which can also be of importance in itself in combination with the previously described embodiments.

A fourth radius R4, starting from the axis of rotation x, extends through the shoulder 14 at a radially outer section of its marginal outer edge, which is simultaneously a section of the first marginal outer edge 27, at an intersection point S. The intersection s is chosen in such a way that it is arranged approximately in the middle of a height of the shoulder 14. The height of shoulder 14 is further preferably formed by measured dimensions M1 and M2 plotted at a perpendicular to this radius R4 at the intersection point S. The measured dimensions M1 and M2 result from the distance starting from the radius R4 to a measuring point MP1 of the shoulder 14 at the furthest distance in the closing direction S and a measured dimension M2 also plotted on a perpendicular, in the opposite direction, up to a dimension point MP2 of the second cutting edge 13, which denotes a lowest point of the second cutting edge 13. These measured dimensions M1 and M2 are correspondingly the same with respect to the intersection S.

The section of the outer edge is practically straight, corresponding to a tangent to the said radius R4 at the intersection s, and this over a considerable dimension, namely at least more than half of its dimension corresponding to the said height.

In this case, it is further preferred that the straight or approximately straight course of the said outer edge extends in the direction of the measuring point MP1 over a larger measured dimension starting from the intersection S than in the opposite direction, in the direction of the measuring point MP2. The straight or approximately straight dimension of the said section of the outer edge in the direction of the measuring point MP1 is also preferred, about 1.2 to 1.8 times the dimension in the opposite direction, and about 1.4 to 1.6 times.

The fourth radius R4 mentioned can coincide with the first radius R1, but it can also be different from this. Likewise, the height h already described can be the same as the height described here, but there may also be a difference.

In particular, it is also preferred that the first cutting edge has only the one described connecting region and/or that the second cutting edge has only the one described connecting region and/or that the third cutting edge has only the one described connecting region.

The above embodiments serve to explain the inventions covered by the application as a whole, which at least independently advance the state of the art by means of the following combinations of features, wherein two, more or all of these combinations of features may also be combined, namely:

A manually operable cutting tool characterized in that the first cutting edge 12 of the first tool leg 2 comprises two first and second cutting regions 15, 16 successively formed in the radial direction R, which transition into each other via a first pointed-tip-like connecting region 19, wherein the first pointed-tip-like connecting region 19 also forms a part of an outer edge 27 of the opening region 35 in the first closing position 35, and that a first radial R1, which originates from the axis of rotation x on the pivot plane E and, viewed against the closing direction S, lies the first pointed-tip-like connecting region 19 from outside, extends through the shoulder 14 approximately at a half height h plotted on a perpendicular a to a second radius R2 running on the pivot plane E, which touches the second cutting edge 13 of the first tool leg 2 at a lowest point 37 viewed against the pivoting direction, wherein the perpendicular a runs through a region 34 of the shoulder 14 that projects the furthest in the pivoting direction S.

A manually operable cutting tool characterized in that the first and second cutting edges 12, 13 of the first tool leg 2 each have two first and second cutting regions 15, 16 and 17, 18 arranged in a radial direction R one after the other, which transition into each other via a first and a second pointed-tip-like connecting region 19, 20, wherein the pointed-tip-like connecting regions 19, 20 are each formed as a convex transition separating the first and second cutting regions 15, 16 and 17, 18, each formed with a concave outer edge 27, and that a straight line G applied externally to the pointed-tip-like connecting regions 19, 20 extends through the shoulder 14 formed between the first and the second cutting edge 12, 13, wherein a projecting dimension v of the shoulder 14 carried perpendicular to the straight line is a fourfold or more one of the lines G in the opposite direction, perpendicular to the straight line, the greatest depth t corresponds to an area of the first cutting region 17 spanned by the line G to the second cutting edge 13.

A manually operable cutting tool, characterized in that the first cutting edge 12 of the first tool leg 2 comprises two first and second cutting regions 15, 16 successively arranged in the radial direction R, which transition into each other via a first pointed-tip-like connecting region 19, and in that the shoulder 14, which is formed only on the first tool leg 2, is divided with regard to a radially outer section of a first outer edge 27 facing the second cutting edge 13, with reference to a fourth radius R4 originating from the axis of rotation x, which extends through the shoulder 14 at an intersection point S in the section related to the intersection approximately in the middle of a height of the shoulder 14, and which section extends about half of its extension or more along a tangent T to the fourth radius R4 at the intersection S, wherein the height results from a measured dimension M1, M2 plotted at the intersection point S respectively perpendicular to a first dimension point MP1 of the shoulder 14 itself furthest away from the fourth radius R4 in the closing direction and up to a second dimension point MP2 of the second cutting edge 13 furthest away against the closing direction, and in that the outer edge in the section, as viewed from the intersection point in each case, transitions into a convex curvature to the first dimension point MP1 and into a concave curvature to the second dimension point MP2.

A manually operable cutting tool characterized in that the first cutting edge 12 across its entire length b and the second cutting edge 13 over substantially its entire length c can be moved on top of each other with a third cutting edge 21 of the second tool leg 2, which extends over a combined length d of the first and second cutting edges 12, 13.

A manually operable cutting tool which is characterized by the fact that the projecting shoulder 14 is formed only on the first tool leg 2.

A manually operable cutting tool which is characterized in that, in a first half of a length e plotted the third cutting edge 21 as viewed from the axis of rotation x in relation to a third radius R3 in a perpendicular projection, a third pointed-tip-like connecting region 24 is formed, which in the first closing position also forms a part of the outer edge 29 of the opening region.

A manually operable cutting tool which is characterized in that the third radius R3 extending from the axis of rotation x on the pivot plane E, which lies on the third pointed-tip-like connecting region 24 as viewed from the outside, against the closing direction S, does not extend through the second tool leg 3 beyond the third pointed-tip-like connecting region 24.

A manually operable cutting tool characterized in that the first pointed-tip-like connecting region 19 and the third pointed-tip-like connecting region 24 are offset from each other in the radial direction R.

A manually operable cutting tool characterized in that the third pointed-tip-like connecting region 24 is formed closer to the axis of rotation x than the first tip-type connecting region 19.

A manually operable cutting tool which is characterized in that the first and second cutting edges 12, 13 of the first tool leg 2 are formed as outer edge 27 of a first contact and support surface 28 of the first tool leg 2, that the third cutting edge 13 of the second tool leg 3 is formed as outer edge 29 of a second contact and support surface (30) of the second tool leg (3), that the first contact and support surface 28 has moved over or aligns with the second contact and support surface 30 in the closing position and that the first and second contact and support surfaces 28, 30 each run on the same continuous plane.

A manually operable cutting tool characterized in that the first cutting region 15 of the first cutting edge 12 and the first cutting region 17 of the second cutting edge 13 extend along the same second radius R2 running on the pivot plane E with respect to the axis of rotation

A manually operable cutting tool characterized in that the length b of the first cutting edge 12 plotted on the second radius R2 up to a point of the first cutting edge 12 that projects furthest in the closing direction corresponds to twice or less of a projecting dimension of this point, perpendicular to the second radius R2.

A manually operable cutting tool which is characterized in that the first contact and support surface 28 of the first tool leg 2 is formed continuously, including the shoulder 14, with a cutting edge 31, 32 having a cutting angle α, α′.

A manually operable cutting tool characterized in that the cutting angle α, α′ is different over the length b, c of the first and/or second cutting edge 12, 13 of the first tool leg 2.

All disclosed features are essential to the invention (on their own, but also in combination with each other). In the disclosure of the application, the disclosure contents of the related/enclosed priority documents (copy of the pre-application) shall hereby be fully included, and also concerning this purpose, features of these documents must be included in claims of the present application. The sub-claims, even without the features of a referenced claim, characterize with their features independent inventive further embodiments of the prior art, in particular, in order to make divisional applications on the basis of these claims. The invention specified in each claim may additionally comprise one or a plurality of the features specified in the preceding description, in particular with reference digits and/or specified in the list of reference digits. The invention also relates to design forms in which some of the features mentioned in the preceding description are not realized, in particular insofar as they are recognizably dispensable for the respective purpose or can be replaced by other technically equivalent means.

### REFERENCE LIST

1 cutting tool
2 first tool leg
3 second tool leg
4 pivot bolts
5 handle section
6 handle section
7 cutting jaw
8 cutting jaw
9 working surface
10 working surface
11 cutting mouth
12 first cutting edge
13 second cutting edge
14 shoulder
15 first cutting region
16 second cutting region
17 first cutting region
18 second cutting region
19 first connecting region
20 second connecting region
21 third cutting edge
22 first cutting region
23 second cutting region
24 third connecting region
25 cable sheath
26 wire
27 first outer edge
28 first contact and support surface
29 second outer edge
30 second contact and support surface
31 cutting edge
32 cutting edge
33 closing region
34 region
35 first opening region
36 second opening region
37 point
38 flank
39 front surface
40 point
41 section
42 concave section
43 line
44 cable
a perpendicular
b length
c length
d length
e length
f radius dimension
j radius dimension
k height
m height
h height
t depth
V projecting dimension
x axis of rotation
E pivot plane
G straight line
M1 measured dimension
M2 measured dimension
MP1 measuring point
MP2 measuring point
R radial direction
R1 first radius
R2 second radius
R3 third radius
R4 fourth radius
s intersection
S closing direction
Z1 first cutting zone
Z2 second cutting zone
α cutting angle
α′ cutting angle
β cutting angle

1-14. (canceled)

15: A manually operable cutting tool comprising:
two tool legs (2, 3) that comprise a first tool leg (2) and a second tool leg (3), which are configured to be pivoted towards each other about an axis of rotation (x) along a pivot plane (E), wherein the tool legs (2, 3) form handle sections (5, 6) on one side of the axis of rotation (x) and a cutting mouth (11) on the other side, wherein working surfaces (9, 10) of the cutting mouth (11) are formed with cutting edges (12, 13, 21), and a working surface (9) of the first tool leg (2) comprises first and second cutting edges (12, 13), wherein the first cutting edge (12) of the first tool leg (2) transitions into a shoulder (14), which projects in relation to the second cutting edge (13) in a closing direction(S), at the transition to the second cutting edge (13), wherein the shoulder (14) first comes into a superimposed position with the second tool leg (3) in a closing region (33) in a first closing position during the movement into a closing position of the cutting tool (1), wherein, in the first closing position, the closing region (33) is, viewed from the axis of rotation (x) in a radial direction (R), formed on a radial end of an opening region (35) remaining between the first cutting edge (12) of the first tool leg (2) and the second tool leg (3) in the first closing position, wherein the first cutting edge (12) of the first tool leg (2) comprises two first and second cutting regions (15, 16) successively formed in the radial direction (R), which transition into each other via a first pointed-tip-like connecting region (19), wherein the first pointed-tip-like connecting region (19) also forms a part of an outer edge (27) of the opening region (35) in the first closing position, wherein a first radius (R1), which originates from the axis of rotation (x) on the pivot plane (E) and, viewed against the closing direction(S), lies on the first pointed-tip-like connecting region (19) from outside, extends through the shoulder (14) approximately at a half height (h) plotted on a perpendicular (a) to a second radius (R2) running on the pivot plane (E), which touches the second cutting edge (13) of the first tool leg (2) at a lowest point (37) viewed against the pivoting direction(S), wherein the perpendicular (a) runs through a region (34) of the shoulder (14) that projects the furthest in the pivoting direction(S) and that the shoulder (14) provides a depth stop for a material to be cut fed within a region of the second cutting edge (13) so that the material cannot enter into the region of the first cutting edge (12) in a radially inward direction when processing in the region of the second cutting edge (13).

16: The manually operable cutting tool (1) according to claim 15, wherein the first and second cutting edges (12, 13) of the first tool leg (2) each comprise two first and second cutting regions (15, 16 and 17, 18) successively arranged in the radial direction (R), which transition into one another via a first and a second pointed-tip-like connecting region (19, 20), wherein the pointed-tip-like connecting regions (19, 20) are each formed as a convex transition that separates the first and second cutting regions (15, 16 and 17, 18) each formed with a concave outer edge (27), and wherein a straight line (G) applied onto the outside of the pointed-tip-like connecting regions (19, 20) extends through the shoulder (14) formed between the first cutting edge and second cutting edge (12, 13), wherein a projecting dimension (v) of the shoulder (14) plotted perpendicular to the straight line (G) corresponds to fourfold or more of a greatest depth (t) of the area, spanned by the straight line (G), of the first cutting region (17) of the second cutting edge (13), the depth being plotted by the straight line (G) in an opposite direction perpendicular to the straight line (G).

17: A manually operable cutting tool (1) comprising two tool legs (2, 3) that comprise a first tool leg (2) and a second tool leg (3), which are configured to be pivoted towards each other about an axis of rotation (x) along a pivot plane (E), wherein the tool legs (2, 3) form handle sections (5, 6) on one side of the axis of rotation (x) and a cutting mouth (11) on the other side, wherein, furthermore, working surfaces (9, 10) of the cutting mouth (11) are formed with cutting edges (12, 13, 21), and a working surface (9) of the first tool leg (2) comprises first and second cutting edges (12, 13), wherein the first cutting edge (12) of the first tool leg (2) at a transition to the second cutting edge (13) transitions into a shoulder (14) projecting in a closing direction (S) in relation to the second cutting edge (13), wherein, in a first closing position, the shoulder (14) first comes into a superimposed position with the second tool leg (3) in a closing region (33) in the first closing position during the movement into a closing position of the cutting tool (1), wherein, in the first closing position, the closing region (33) is, viewed from the axis of rotation (x) in a radial direction (R), formed on a radial end of an opening region (35) remaining between the first cutting edge (12) of the first tool leg (2) and the second tool leg (3) in the first closing position, wherein the first cutting edge (12) of the first tool leg (2) comprises two first and second cutting regions (15, 16) successively arranged in the radial direction (R), which transition into one another via a first pointed-tip-like connecting region (19), wherein the shoulder (14), which is formed only on the first tool leg (2), extends through with regard to a radially outer section of a first outer edge (27) facing the second cutting edge (13), relating to a fourth radius (R4) originating from the axis of rotation (x), which extends through the shoulder (14) at an intersection(s) in the section with respect to the intersection(s) approximately in the middle of a height of the shoulder (14), and which section extends approximately more than half of its extension or more along a tangent (T) to the fourth radius (R4) at the intersection(s), wherein the height results from a measured dimension (M1, M2) plotted perpendicular to the fourth radius (R4) up to a first dimension point (MP1) of the shoulder (14) itself that is furthest away from the fourth radius (R4) in the closing direction and up to a second dimension point (MP2) of the second cutting edge (13) furthest away from the closing direction against the closing direction, and wherein the outer edge in the section, viewed from the intersection(s), transitions into a convex curvature to the first dimension point (MP1) and into a concave curvature to the second dimension point (MP2).

18: A manually operable cutting tool (1) comprising two tool legs (2, 3) that comprise a first tool leg (2) and a second tool leg (3), which are configured to be pivoted towards each other about an axis of rotation (x) along a pivot plane (E), wherein the tool legs (2, 3) form handle sections (5, 6) on one side of the axis of rotation (x) and a cutting mouth (11) on the other side, wherein working surfaces (9, 10) of the cutting mouth (11) are formed with cutting edges (12, 13, 21), and a working surface (9) of the first tool leg (2) comprises first and second cutting edges (12, 13), wherein the first cutting edge (12) of the first tool leg (2) transitions into a shoulder (14), which projects in relation to the second cutting edge (13) in a closing direction(S), at the transition to the second cutting edge (13), wherein the shoulder (14) first comes into a superimposed position with the second tool leg (3) in a closing region (33) in a first closing position during the movement into a closing position of the cutting tool (1), wherein the closing region (33) is, viewed from the axis of rotation (x) in a radial direction (R), in the first closing position formed on a radial end of an opening region (35) remaining between the first cutting edge (12) of the first tool leg (2) and the second tool leg (3) in the first closing position, wherein the first cutting edge (12) of the first tool leg (2) comprises two first and second cutting regions (15, 16) successively formed in the radial direction (R), which transition into each other via a first pointed-tip-like connecting region (19), wherein the first pointed-tip-like connecting region (19) also forms a part of an outer edge (27) of the opening region (35) in the first closing position, and that a first radius (R1), which originates from the axis of rotation (x) on the pivot plane (E) and, viewed against the closing direction(S), lies on the first pointed-tip-like connecting region (19) from outside, extends through the shoulder (14) approximately at a half height (h) plotted on a perpendicular (a) to a second radius (R2) running on the pivot plane (E), which touches the second cutting edge (13) of the first tool leg (2) at a lowest point (37) viewed against the pivoting direction (S), wherein the perpendicular (a) runs through a region (34) of the shoulder (14) that projects the furthest in the pivoting direction(S) and that the projecting shoulder (14) is only formed on the first tool leg (2).

19: The manually operable cutting tool (1) according to claim 15, wherein the first and second cutting edges (12, 13) of the first tool leg (2) each comprise two first and second cutting regions (15, 16 and 17, 18) successively arranged in the radial direction (R), which transition into one another via a first and second pointed-tip-like connecting region (19, 20), wherein the pointed-tip-like connecting regions (19, 20) are each formed as a convex transition that separates the first and second cutting regions (15, 16 and 17, 18) each formed with a concave outer edge (27), and wherein a straight line (G) applied onto the outside of the pointed-tip-like connecting regions (19, 20) extends through the shoulder (14) formed between the first cutting edge and second cutting edge (12, 13), wherein a projecting dimension (v) of the shoulder (14) plotted perpendicular to the straight line (G) corresponds to fourfold or more of the greatest depth (t) of the area, spanned by the straight line (G), of the first cutting region (17) of the second cutting edge (13) plotted by the straight line (G) in the opposite direction perpendicular to the straight line (G) and that the projecting shoulder (14) is only formed on the first tool leg (2).

20: The cutting tool according to claim 15, wherein the first cutting edge (12), across an entire length (b) of the first cutting edge, and the second cutting edge (13), across approximately an entire length (c) of the second cutting edge, are movable on top of one another with a third cutting edge (21) of the second tool leg (2) extending across a combined length (d) of the first cutting edge and the second cutting edge (12, 13).

21: The cutting tool according to claim 15, wherein the projecting shoulder (14) is formed only on the first tool leg (2).

22: The cutting tool according to claim 20, wherein, in a first half of a length (e) of the third cutting edge (21) plotted in a perpendicular projection with respect to a third radius (R3) as viewed from the axis of rotation (x), a third pointed-tip-like connecting region (24) is formed, which also forms a part of the outer edge (29) of the opening region in the first closing position.

23: The cutting tool according to claim 22, wherein the third radius (R3), which originates from the axis of rotation (x) on the pivot plane (E), viewed against the closing direction(S), lies on the first on the third pointed-tip-like connecting region (24) from outside, does not extend through the second tool leg (3) beyond the third pointed-tip-like connecting region (24).

24: The cutting tool according to claim 22, wherein the first pointed-tip-like connecting region (19) and the third pointed-tip-like connecting region (24) are offset in the radial direction (R) with respect to each other.

25: The cutting tool according to claim 24, wherein the third pointed-tip-like connecting region (24) is formed closer to the axis of rotation (x) than the first pointed-tip-like connecting region (19).

26: The cutting tool according to claim 15, wherein the first and second cutting edges (12, 13) of the first tool leg (2) are formed as the outer edge (27) of a first contact and support surface (28) of the first tool leg (2), wherein a third cutting edge (13) of the second tool leg (3) is formed as the outer edge (29) of a second contact and support surface (30) of the second tool leg (3), wherein the first contact and support surface (28) with the second contact and support surface (30) is partly superimposed over one another or aligned and partially overlaps in the closing position and wherein the first and second contact and support surfaces (28, 30) each run on or along a same continuous plane.

27: The cutting tool according to claim 15, wherein the first cutting region (15) of the first cutting edge (12) and the first cutting region (17) of the second cutting edge (13) extend along the same second radius (R2) running on the pivot plane (E) with respect to the axis of rotation (x).

28: The cutting tool according to claim 15, wherein the length (b) of the first cutting edge (12) plotted on the second radius (R2) up to a point of the first cutting edge (12) projecting furthest in the closing direction corresponds to twice or less of a projecting dimension of that point perpendicular to the second radius (R2).

29: The cutting tool according to claim 26, wherein the first contact and support surface (28) of the first tool leg (2) is formed continuously, including the shoulder (14) with a cutting edge (31, 32) comprising a cutting angle (α, α′).

30: The cutting tool according to claim 29, wherein the cutting angle (α, α′) is different across the length (b, c) of the first cutting edge (12) and/or the second cutting edge (13) of the first tool leg (2).
